(19) United States
(12) Patent Application Publication
(10) Pub. No.: US 2008/0062188 A1
(43) Pub. Date: Mar. 13, 2008

(54) METHOD OF AND APPARATUS FOR SAVING VIDEO DATA

(75) Inventors: Keun-kyoung PARK, Seoul (KR); Chan-sik PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/737,369

(22) Filed: Apr. 19, 2007

(30) Foreign Application Priority Data
Sep. 8, 2006 (KR) 10-2006-0086984

(51) Int. Cl. G06F 12/00

(52) U.S. Cl. 345/564

(57) ABSTRACT

A method of and apparatus are provided for saving video data. The method for saving video data in a memory includes mapping the memory such that data of a plurality of consecutive lines in a video frame is recorded one after another in a single memory bank at intervals of a specified number of bytes and recording data of the lines in the memory according to the mapping

### CROSS-REFERENCE TO RELATED PATENT APPLICATION

This application claims priority from Korean Patent Application No. 10-2006-0086984, filed on Sep. 8, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to saving data, and more particularly, to saving video data that is accessed in block units.

2. Description of the Related Art

With the development of information communication technology, including the Internet, there is an increasing demand for communication of video data as well as text data and voice data. Related text-based communication technologies cannot satisfy various consumers' demands. As a result, a multimedia service presented in various forms like texts, video, and music has been developed. In particular, video data is voluminous, and thus requires a large bandwidth to be transmitted. To compress and then transmit video data, different compression methods, such as moving picture experts group (MPEG)-1, MPEG-2, and MPEG-4, have been developed.

The compression methods like MPEG-1, MPEG-2, and MPEG-4 are referred to as code and decode (CODEC). Generally, processing of video data using CODEC is performed in units of a block. Motion estimation, motion compensation, and deblocking correspond to block-based video data processing.

FIGS. 1A and 1B are views for explaining a method of saving video data in a memory according to the related art.

In FIGS. 1A and 1B, data corresponding to a 1920×1088 video frame is saved in a memory. Referring to FIG. 1A, the video frame to be saved is composed of 1920 horizontal pixels and 1088 vertical pixels. In general, one pixel contains information about one of luminance (Y) and chrominance (Cb or Cr) and the information is expressed in eight bits, i.e., one byte.

As mentioned above, video data illustrated in FIG. 1A is processed in units of a block. At this time, a block indicates a unit 101 or 102 composed of consecutive pixels within a video frame and the size of the block varies with the type of CODEC and the type of video data processing to be performed. In FIG. 1, the block has a size of 4×4.

FIG. 1B is a view for explaining a method of saving data corresponding to the video frame shown in FIG. 1 in a memory. The memory is generally divided into four memory banks A through D. This is because when data is recorded in or read from different banks, the efficiency of using the memory can be improved by ‘bank interleaving’ that enables a command transmission period for transmitting addresses of data and a data transmission period for transmitting data to overlap.

Referring to FIG. 1B, data of a line 0 in the video frame illustrated in FIG. 1A is recorded in the bank A and data of a line 1 in the video frame illustrated in FIG. 1A is recorded in the bank B. After data of a line 2 and data of a line 3 are sequentially recorded in the bank C and the bank D, data of a line 4 is recorded in the bank A.

A case where the block 101 is accessed through a 64-bit data bus to process video data will be considered. In order for a video data processing module to access data of a 4×4 block, data of horizontal pixels 0, 1, 2, and 3 of the lines 0, 1, 2, and 3 should be accessed. Thus, each of the memory banks A, B, C, and D should be accessed one time, i.e., a total of four accesses are required. Since the 64-bit data bus is used and data of each pixel is composed of 8 bits, data of horizontal pixels 0, 1, 2, 3, 4, 5, 6, and 7 of the line 0 is accessed in the bank A. Similarly, data of eight horizontal pixels is accessed in each of the banks, B, C, and D. At this time, the time for data accesses is obtained by overlapping a command transmission period and a data transmission period using bank interleaving.

In the method for saving video data according to the related art, data of each line is recorded in a memory bank in line units. For example, in the bank A, data of the line 4 is recorded after data of the line 0 is entirely recorded and then data of the line 8 is recorded. Such an operation is repeated until the video frame illustrated in FIG. 1A is entirely recorded.

According to a memory map of FIG. 1B, in spite of the use of bank interleaving, data of horizontal pixels 4, 5, 6, and 7 of the lines 0, 1, 2, and 3 as well as data of the 4×4 block 101 is unnecessarily accessed during current video data processing, resulting in inefficiency in using the memory. When only odd-numbered lines or even-numbered lines are accessed as in field mode motion compensation, data of horizontal pixels 4, 5, 6, and 7 of the odd-numbered lines or even-numbered lines is accessed, resulting in inefficiency in using the memory.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for saving video data, in which data accesses to unnecessary pixels are reduced, and a computer-readable recording medium having recorded thereon a program for implementing the method.

According to an aspect of the present invention, there is provided a method for saving video data in a memory, the method including mapping the memory wherein data of a plurality of consecutive lines in a video frame is recorded one after another in a single memory bank at intervals of a specified number of bytes, and recording data of the lines in the memory according to the mapping.

The mapping may include mapping the memory wherein data of consecutive two lines in the video frame is recorded one after the other in the single memory bank at intervals of specified numbers of bytes.

The consecutive two lines may be two consecutive odd or even lines in the video frame.

According to another aspect of the present invention, there is provided an apparatus for saving video data in a memory, the apparatus including a control unit that maps the memory such that data of a plurality of consecutive lines in a video frame is recorded one after another in a single memory bank at intervals of a specified number of bytes and the memory that records data of the lines according to the mapping.

The control unit may map the memory such that data of consecutive two lines in the video frame is recorded one after the other in the single memory bank at intervals of specified numbers of bytes.

The consecutive two lines may be two consecutive odd or even lines in the video frame.

The specified number of bytes may be two bytes or four bytes.

According to another aspect of the present invention, there is provided a computer-readable recording medium having recorded thereon a program for implementing the method for saving video data in a memory.

### BRIEF DESCRIPTION OF THE DRAWINGS

The above and other aspects of the present invention will become more apparent by describing in detail an exemplary embodiment thereof with reference to the attached drawings in which:

FIGS. 1A and 1B are views for explaining a related method of saving video data in a memory;

FIG. 2 illustrates a memory map for saving video data according to an exemplary embodiment of the present invention;

FIG. 3 is a flowchart illustrating a method of saving video frame data in a memory according to an exemplary embodiment of the present invention; and

FIG. 4 is a block diagram of an apparatus for saving video data according to an exemplary embodiment of the present invention.

### DETAILED DESCRIPTION OF THE INVENTION

Hereinafter, an exemplary embodiment of the present invention will be described in detail with reference to the accompanying drawings.

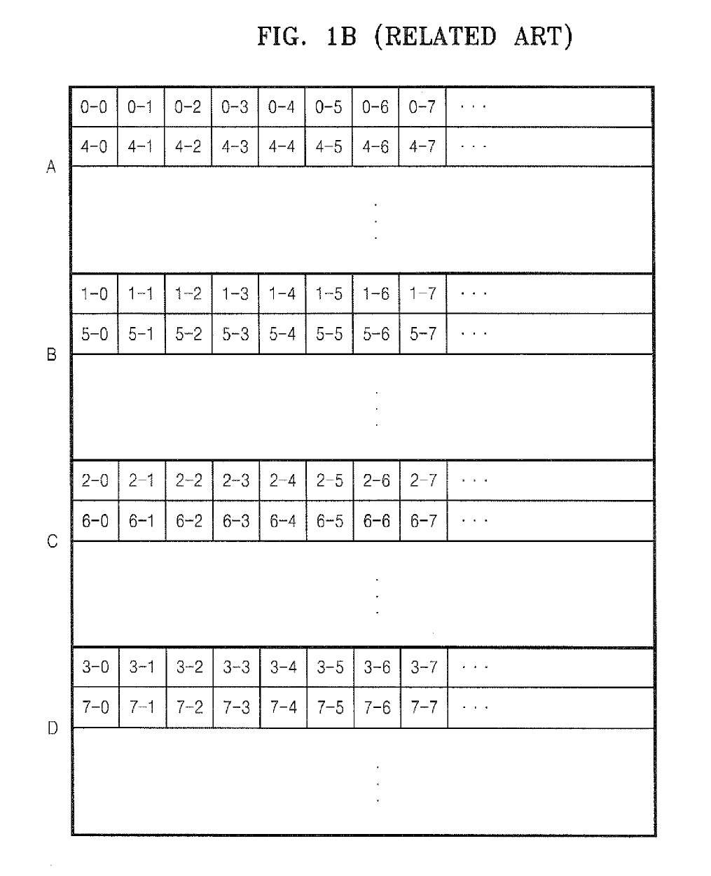

FIG. 2 illustrates a memory map for saving video data according to an exemplary embodiment of the present invention.

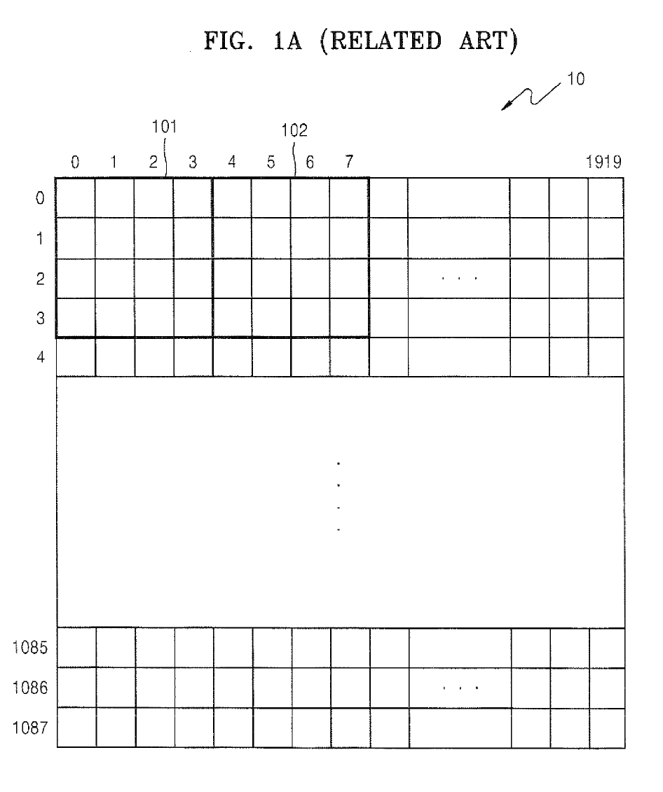

In FIG. 2, data of the video frame illustrated in FIG. 1A is saved in a memory including four memory banks.

Referring to FIG. 2, the memory is mapped so that data of a plurality of consecutive lines in the video frame can be recorded in the memory banks. In the first memory bank, data of the line 0 and data of the line 2 are periodically recorded one after the other. A small square in FIG. 2 indicate data of a pixel in the video frame illustrated in FIG. 1A and corresponds to eight bits, i.e., one byte, as mentioned above. Thus, it can be seen that the line 0 and the line 2 are recorded one after the other in the first memory bank at intervals of 4 bytes.

The line 1 and the line 3 are recorded one after the other in the second memory bank at intervals of four bytes. Next, data of the line 4 and the line 6 is recorded in the third memory bank and data of the line 5 and the line 7 is recorded in the fourth memory bank. After recording in the fourth memory bank is completed, data of the line 8 is recorded in the first memory bank. The processes described above are repeated until all the lines of the video frame illustrated in FIG. 1A are recorded.

After all the lines of the video frame are recorded, video data saved as illustrated in FIG. 2 is accessed through a 64-bit data bus as presented below. If data of the first block 101 illustrated in FIG. 1A is accessed, only 64 bits of each of the first memory bank and the second memory bank are accessed once because the first block 101 is composed of horizontal pixels 0, 1, 2, and 3 of the lines 0, 1, 2, and 3. The time required to access the first memory bank and the second memory bank can be reduced using bank interleaving. Thus, in this case, when the first memory bank or the second memory bank is accessed, there is no data access with respect to pixels that are unnecessary to current video data processing.

When only data of odd lines or even lines included in a block is required like in field mode motion compensation, only the first memory bank or the second memory bank is accessed. This is because the memory is mapped so that data of the odd lines and even lines included in a block is recorded separately. However, it can be easily understood by those skilled in the art that when data of a plurality of lines is recorded separately, recording may not be necessarily performed separately with respect to odd lines and even lines and various combinations are available like in a case where recording is performed separately with respect to alternate lines.

In video data processing, if data of a block that is larger than 4×4 needs to be accessed, data of 4×4 blocks is accessed repetitively. For example, when a 4×8 block including the first block 101 and the second block 102 illustrated in FIG. 1A needs to be accessed, the first memory bank illustrated in FIG. 2 is accessed two times to access data of horizontal pixels 0, 1, 2, 3, 4, 5, 6, and 7 of the lines 0 and 2 and the second memory bank is accessed two times to access data of horizontal pixels 0, 1, 2, 3, 4, 5, 6, and 7 of the lines 1 and 3. Similarly, when data of an 8×8 block needs to be accessed, 4×4 blocks are accessed four times.

For a block that is not a multiple of a 4×4 block, such as a 19×19 block or an 18×9 block, a data access with respect to pixels that are unnecessary to current video data processing is minimized, thereby reducing the number of data accesses.

When video data is accessed using a 32-bit data bus, four pixels that can be accessed at a time. Therefore, the video data can be recorded using a different method than the memory map illustrated in FIG. 2. Data of a plurality of lines are recorded one after another in different memory banks at intervals of two bytes. For example, data of horizontal pixels 0 and 1 of the first line 0 is recorded in the first memory bank and then data of horizontal pixels 0 and 1 of the line 2 is recorded in the second memory.

The intervals at which data of a plurality of lines are recorded one after another in a memory bank may vary without being limited to two bytes or four bytes. The intervals which minimize the number of data accesses may be used according to the transmission speed of a data bus for transmitting data saved in the memory and the size of a data block to be accessed.

The first through fourth memory banks illustrated in FIG. 2 may be included in one memory or different memories. If the first through fourth memory banks are included in different memories, video data can be read from each of the memories at the same time, thereby increasing the speed of block-based data reading, as can be easily understood by those skilled in the art.

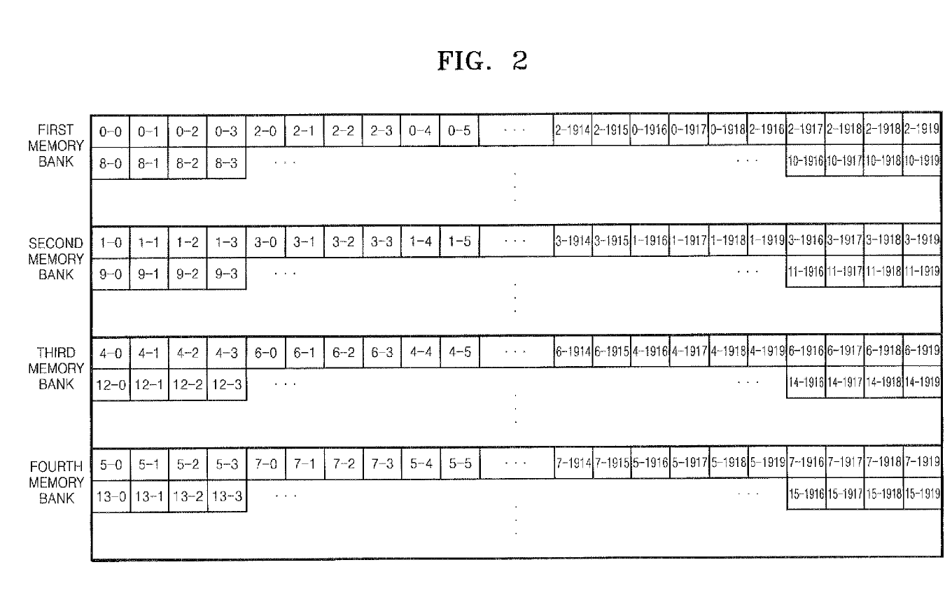

FIG. 3 is a flowchart illustrating a method of saving video frame data in a memory according to an exemplary embodiment of the present invention.

In operation 300, the memory is mapped such that every data of a plurality of lines in a video frame are recorded one after another in a memory bank at specified intervals.

Since four memory banks generally exist in a single memory, it is preferable that data of the same number of lines be stored in the four memory banks. Thus, the memory is mapped so that data of a plurality of lines can be recorded in the order of the first memory bank, then the second memory bank, then the third memory bank, then the fourth memory bank, then the first memory bank, and the like.

Although data of at least three lines can be recorded in a memory bank, it is preferable that data of two lines be recorded in a memory bank as illustrated in FIG. 2. At this time, two lines may be consecutive ones in a video frame. The consecutive two lines may be consecutive odd or even lines. Since accesses to only data of consecutive odd or even lines may be required as in field mode motion compensation as mentioned above, data of two consecutive odd or even lines is recorded in the same memory bank.

When data of a plurality of lines is recorded in a memory bank, it is preferable that the data of the plurality of lines be recorded one after another at specified intervals. As illustrated in FIG. 2, two consecutive lines are periodically recorded one after the other in each memory bank.

When a data bus for accessing data saved in a memory is generally a 64-bit data bus and two consecutive lines are saved in a single memory bank, it is preferable that the memory be mapped so that the two lines are recorded one after the other at intervals of four bytes to access every four bytes of each of the two lines. However, the optimal intervals may vary according to the transmission speed of a data bus for transmitting data saved in a memory and the size of a data block to be accessed.

In operation 302, video data is recorded in the memory according to the memory map.

Since video data processing like motion estimation, motion compensation, and deblocking is performed in units of a specified block, the video data recorded in the memory in operation 302 is accessed in units of a block for the video data processing.

Video data recording in operation 302 is performed with respect to the entire video frame according to the memory map and the recorded video data is read for video data processing. Since data of the video frame is saved according to the memory map, accesses to unnecessary pixels can be reduced during the data reading operation.

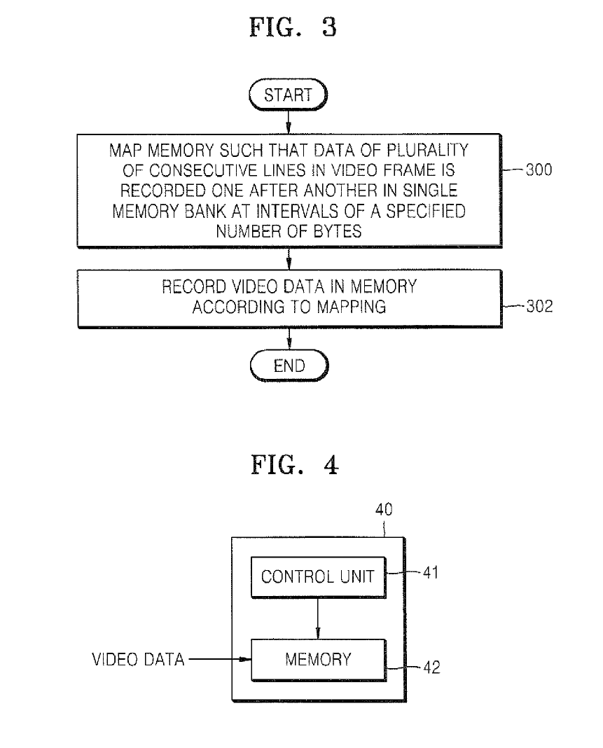

FIG. 4 is a block diagram of an apparatus 40 for saving video data according to an exemplary embodiment of the present invention.

Referring to FIG. 4, the apparatus 40 includes a control unit 41 and a memory 42.

The control unit 41 maps the memory 42 such that data of a plurality of consecutive lines in a video frame is recorded one after another in a single memory bank at intervals of specified bytes.

Since four memory banks generally exist in a memory, it is preferable that data of the same number of lines be stored in the four memory banks. Thus, the memory 42 is mapped so that data of a plurality of lines can be recorded in the order of the first memory bank, then the second memory bank, then the third memory bank, then the fourth memory bank, then the first memory bank, and the like.

Although data of at least three lines can be recorded in a memory bank, it is preferable that data of two lines be recorded in a memory bank as illustrated in FIG. 2. At this time, two lines may be consecutive in a video frame. The two consecutive lines may be two consecutive odd or even lines.

When two consecutive lines are saved in a single memory bank, it is preferable that the control unit 41 map the memory 42 such that the two lines are recorded one after the other at intervals of 4 bytes to access every 4 bytes of each of the two lines.

The memory 42 is required to record the video data according to the mapping of the control unit 41.

The video data is recorded in the memory 42 according to the mapping of the control unit 41 with respect to the entire video frame and the recorded video data is read for video data processing. Since the video data is stored according to the mapping of the control unit 41 according to the present invention, accesses to unnecessary pixels can be reduced during the data reading operation.

Meanwhile, the present invention can also be exemplarily embodied as a computer-readable code on a computer-readable recording medium. The computer-readable recording medium is any data storage device that can store data which can be thereafter read by a computer system. Examples of computer-readable recording media include read-only memory (ROM), random-access memory (RAM), CD-ROMs, magnetic tapes, floppy disks, and optical data storage devices. The computer-readable recording medium can also be distributed over network of coupled computer systems so that the computer-readable code is stored and executed in a decentralized fashion.

As described above, according to an exemplary embodiment of the present invention, data of a plurality of consecutive lines is stored in a single memory bank, thereby reducing the number of accesses to a memory during a process of reading data in units of a predetermined block for video data processing.

The use of a data bus used for reading data is maximized by reducing the number of accesses to the memory, thereby improving the speed of video data processing.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of saving video data in a memory, the method comprising:
mapping the memory, so that data of a plurality of consecutive lines in a video frame is recorded one after another in a single memory bank at intervals of a specified number of bytes; and
recording data of the lines in the memory according to the mapping.

2. The method of claim 1, wherein the mapping comprises mapping the memory so that data of two consecutive lines in the video frame is recorded one after the other in the single memory bank at intervals of the specified number of bytes.

3. The method of claim 2, wherein the two consecutive lines are two consecutive odd lines or two consecutive even lines in the video frame.

4. The method of claim 2, wherein the specified number of bytes are two bytes or four bytes.

5. The method of claim 1, wherein the video frame is a 1920×1088 video frame.

6. The method of claim 1, wherein the memory comprises four memory banks.

7. An apparatus for saving video data in a memory, the apparatus comprising:
a control unit which maps the memory so that data of a plurality of consecutive lines in a video frame is recorded one after another in a single memory bank at intervals of a specified number of bytes;
wherein the memory records data of the lines according to the mapping.

8. The apparatus of claim 7, wherein the control unit maps the memory so that data of two consecutive lines in the video frame is recorded one after the other in the single memory bank at intervals of the specified number of bytes.

9. The apparatus of claim 8, wherein the two consecutive lines are two consecutive odd lines or two consecutive even lines in the video frame.

10. The apparatus of claim 8, wherein the specified number of bytes are two bytes or four bytes.

11. The apparatus of claim 7, wherein the video frame is a 1920×1088 video frame.

12. The apparatus of claim 7, wherein the memory comprises four memory banks.

13. A computer-readable recording medium having recorded thereon a program for implementing a method of saving video data in a memory, the method comprising:
mapping the memory, so that data of a plurality of consecutive lines in a video frame is recorded one after another in a single memory bank at intervals of a specified number of bytes; and
recording data of the lines in the memory according to the mapping.

14. The computer-readable recording medium of claim 13, wherein the mapping comprises mapping the memory so that data of two consecutive lines in the video frame is recorded one after the other in the single memory bank at intervals of the specified number of bytes.

15. The computer-readable recording medium of claim 14, wherein the two consecutive lines are two consecutive odd lines or two consecutive even lines in the video frame.

16. The computer-readable recording medium of claim 14, wherein the specified bytes are two bytes or four bytes.

17. The computer-readable recording medium of claim 13, wherein the video frame is a 1920×1088 video frame.

18. The computer-readable recording medium of claim 13, wherein the memory includes four memory banks.
